(19) United States
(12) Patent Application Publication
(10) Pub. No.: US 2025/0282168 A1
(43) Pub. Date: Sep. 11, 2025

(54) METHOD AND DEVICE FOR MARKING A CONTAINER CONTAINING A MEDICINAL SUBSTANCE

(71) Applicants: LASER ENGINEERING APPLICATIONS, Seraing (BE); ASEPTIC TECHNOLOGIES, Les Isnes (BE)

(72) Inventors: Axel Stefan M KUPISIEWICZ, Neupré (BE); Laurent LIROT, Liège (BE); Alain DUTT, Plainevaux (BE); Julien MARECHAL, Houston, TX (US); Alain THIRY, Marchin (BE)

(21) Appl. No.: 18/860,298

(22) PCT Filed: Apr. 25, 2023
(86) PCT No.: PCT/EP2023/060722

§ 371 Date: Oct. 25, 2024

(30) Foreign Application Priority Data
Apr. 26, 2022 (BE) 2022/5305

(51) Int. Cl. B41M 5/26; A61J 1/14; B23K 26/0622; B23K 26/352

(52) U.S. Cl. CPC B41M 5/267; A61J 1/1468; B23K 26/0624; B23K 26/352; A61J 2205/10

(57) ABSTRACT

The disclosure relates to a method for marking a container comprising a vial containing a medicinal substance and closed by a cap secured to the vial by a ring. With the container being at least partially covered with frost, the method further comprises a step of laser marking the ring through the frost. The disclosure also relates to a device for marking a container.

### CROSS-REFERENCE TO RELATED APPLICATION(S)

This present application is a national stage application of International Patent Application No. PCT/EP2023/060722, filed Apr. 25, 2023, which claims priority to Belgium Application No. 2022/5305, filed Apr. 26, 2022, the disclosures of which are hereby incorporated by reference in their entireties.

### TECHNICAL FIELD

This disclosure concerns a method and a device for marking a container containing a medicinal substance.

### BACKGROUND

Medicinal substances (such as vaccines) or other biological substances (such as cells) are sometimes preserved in containers (such as vials) stored at very low temperatures. Certain information must appear on these containers, but the problem of marking the information arises when the containers are covered with frost. When the containers are removed from the storage enclosure at very low temperatures, frost appears on the containers.

To this end, the document WO2016069984 proposes applying a label to the container prior to the low-temperature storage. The label is then laser-marked in an enclosure with storage conditions such that no frost forms. The document US20080178988 proposes the application of a marked and pre-heated label to the frozen container.

The disadvantage of the methods described in these documents is that the glue used to attach the label may migrate into the containers, thereby risking damaging the substance contained in the container. In addition, if the label is applied to the vial before the storage at low temperatures, the glue must be cold-resistant. This may generate high costs. Finally, these methods require complex devices for marking the containers, for marking in an enclosure under storage conditions or for pre-heating the label. These methods are therefore complex.

Generally speaking, there is a need for a simpler method and device for marking pharmaceutical containers configured to be removed from a storage enclosure at very low temperatures. There is therefore a need for a simpler method and device for marking pharmaceutical containers covered with frost.

### SUMMARY

To this end, the disclosure proposes a method for marking a container comprising a vial containing a medicinal substance and closed by a cap secured to the vial by a ring, the container being at least partially covered with frost. The method comprises a step of laser marking the ring through the frost.

In one embodiment, the medicinal substance consists of cells.

According to a embodiment, at least one operating parameter of the laser is selected from the group comprising:
A wavelength between 510 nm and 1200 nm, preferably between 1000 nm and 1100 nm, more preferably at 1064 nm;
A power of less than 20 W, preferably less than 10 W, more preferably less than 4 W, more preferably less than 3 W, more preferably less than 2 W;
A marking speed of between 4 and 100 mm² per second, preferably between 20 and 80 mm² per second;
A laser pulse duration of between 1 and 350 ns nanoseconds, preferably between 4 and 100 ns;
A repetition rate between 2 and 4000 kHz and preferably between 50 and 200 kHz; and
An intensity of 1 mJ per pulse, preferably between 10 and 100 μJ.

In one embodiment, the laser is a fiber laser.

In one embodiment, the ring is marked using at least two passes of the laser on the ring, preferably three passes, and more preferably four passes.

In one embodiment, the ring surrounds the cap and comprises a collar on which the laser marking step is carried out.

In one embodiment, the ring surrounds the cap leaving an uncovered portion of the top face of the cap for the access to the inside of the container by a needle through the cap, the container further comprising a partially or totally removable cap which covers the uncovered portion of the top face of the cap and which is outside the marking area of the ring.

In one embodiment, the cap is made of a thermoplastic material.

In one embodiment, the vial is made of a polymer, preferably a cyclic olefin copolymer or a cyclic olefin polymer.

In one embodiment, prior to the marking step, the container has been stored at −80° C. or below.

According to one embodiment, the marking is chosen from the group of data comprising an expiry date, an individual code, a batch number, an anti-fraud code, a normative code, or a combination of these data.

In one embodiment, the marking is included in a decorative element of the container.

In one embodiment, the marking comprises identification data for identifying the container, a portion of the bits of the identification data define the position of an invisible anti-fraud code produced by the same method.

In one embodiment, during marking, the container is immobile and the laser is mobile.

In one embodiment, the marking comprises a 12×12 or 14×14 code on an area of 2 mm×2 mm or a 10×24 code on an area of 2 mm×4 mm.

In one embodiment, the marking is repeated over at least a portion of the circumference of the ring.

The disclosure also relates to a device for marking a container comprising a vial containing a medicinal substance and closed by a cap secured to the vial by a ring, the container being at least partially covered with frost, the device comprising a laser capable of marking the ring through the frost. The device is suitable for implementing the method.

According to one embodiment, at least one operating parameter of the laser is selected from the group comprising:
A wavelength between 510 nm and 1200 nm, preferably between 1000 nm and 1100 nm, more preferably at 1064 nm;
A power of less than 20 W, preferably less than 10 W, more preferably less than 4 W, more preferably less than 3 W, more preferably less than 2 W;
A marking speed of between 4 and 100 mm² per second, preferably between 20 and 80 mm² per second;
A laser pulse duration of between 1 and 350 ns nanoseconds, preferably between 4 and 100 ns;
A repetition rate between 2 and 4000 kHz and preferably between 50 and 200 kHz; and
An intensity of 1 mJ per pulse, preferably between 10 and 100 μJ.

In one embodiment, the laser is a fiber laser.

In one embodiment, during marking, the container is immobile and the laser is mobile.

The use of the verb “comprise” and its variants, as well as its conjugations in this document, may not in any way exclude the presence of elements other than those mentioned. The use in this document of the indefinite article “a”, “an”, or the definite article “the” to introduce an element does not exclude the presence of a plurality of these elements.

The terms “first”, “second”, “third”, etc. are used in this scope of this document exclusively to differentiate between different elements, without implying any order between these elements.

All the preferred embodiments and all the advantages of the method according to the disclosure are transposed mutatis mutandis to the present device and vice versa. The various embodiments may be considered individually or in combination.

### BRIEF DESCRIPTION OF THE FIGURES

Further characteristics and advantages of the present disclosure will become apparent from the following detailed description, for the understanding of which reference is made to the attached figures which show:

FIG. 1 is a schematic view of an embodiment of a container to which the method may be applied;

FIG. 2 is a cross-sectional view of a container as shown in FIG. 1, in an assembled configuration; and

FIG. 3 is a view of a container with a marking according to the method.

The drawings in the figures are not to scale. Similar elements are generally denoted by similar references in the figures. In the scope of this document, the same or similar elements may have the same references. Furthermore, the presence of reference numbers or letters in the drawings may not be considered as limiting, even when these numbers or letters are indicated in the claims.

### DETAILED DESCRIPTION

The disclosure relates to a method for marking a container comprising a vial containing a medicinal substance and closed by a cap secured to the vial by a ring. The container is at least partially covered in frost. The method comprises a step of laser marking the ring through the frost. This allows an easier marking. The method also allows the substance contained in the vial to be marked without any risk of contamination.

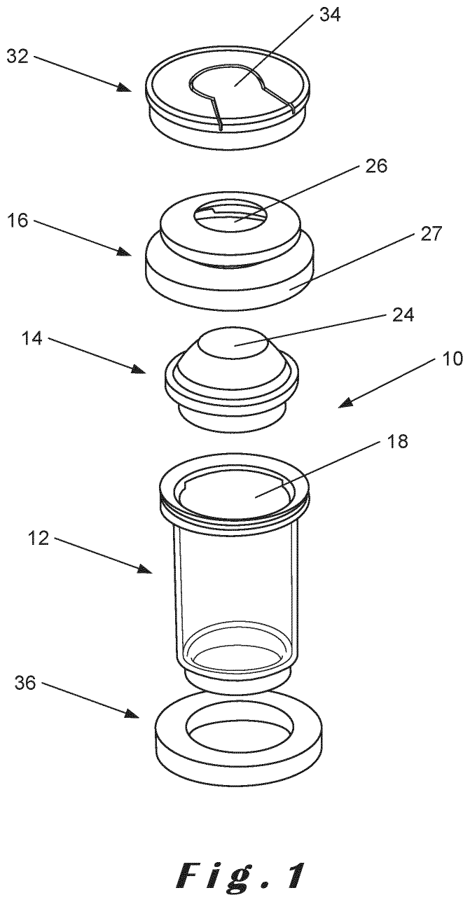

FIG. 1 illustrates an example of embodiment of a container 10 used for marking according to the method of the disclosure. The container 10 may comprise a vial 12 for receiving the medicinal substance. A cap 14 closes the vial 12 at the level of the neck 18 of the vial 12. The container 10 also comprises a ring 16 which secures the cap 14 to the vial 12.

The substance may be a medicinal or pharmaceutical substance. The use in this document of the expression “medicinal substance” or “pharmaceutical substance” covers all types of medicinal product, whether chemical or biological, as well as all other biological substances requiring low-temperature storage, such as cells for example. The substance is preferably fluid or liquid. The substance may be configured to be injected, in particular with a syringe. The substance may be injected into the patient all at once. The container 10 may hold a predefined quantity of medicinal substance. Preferably, the container 10 may receive a single dose. The quantity of substance then corresponds to what is configured to be administered to the patient at one time.

The container 10 is configured to be stored for an indefinite period in an environment at −80° C. or below. This allows to preserve a substance for a long time by rendering it inert. The vial 12 is made of a material compatible with the substance and capable of withstanding low temperatures as indicated above. The material may therefore be a polymer, for example cyclic olefin copolymer (or COC) or cyclic olefin polymer, which are amorphous polymers. The material used is not glass as it is not suitable for storage at temperatures such that frost may appear on leaving storage, particularly at the temperatures mentioned above. The volume of the vial is, for example, between 0.2 and 100 ml. For small volumes, the container may be provided with a baseplate 36 attached to the base of the vial 12; this allows to keep the container upright, even though the small-diameter vial 12 may tip over under the weight of the cap and the ring.

FIG. 2 shows the container 10 of FIG. 1 in its assembled configuration. The cap 14 allows to seal the vial 12, preventing the medicinal substance from leaking out of the vial 12 when the container 10 is being handled. The cap 14 may be attached by a screw thread to the vial 12; preferably, the cap 14 is inserted by translation into the neck 18 of the vial 12. The outer wall 20 of the cap works with the inner wall 22 of the vial and the ring 16 to seal the container 10.

The cap 14 is made of a material resistant to the low temperatures mentioned above. The access to the inside of the container may be gained by removing the cap; preferably, the access to the inside of the container is gained through the cap 14. To do this, the cap 14 may be pierced by a top face 24 by a needle in order to introduce the medicinal substance into the vial 12 and/or collect the medicinal substance from the vial 12. The material of the cap 14 may preferably be resealed after being pierced by the needle-in particular after the medicinal substance has been introduced through the cap by the needle. The material chosen may combine elastic properties-useful for sealing the container-and thermoplastic properties-useful for re-sealing after piercing by a needle. Such a material may be an elastomer, such as thermoplastic elastomer (TPE).

The ring 16 allows to secure the cap 14 to the vial 12 and ensures that the cap 14 is held in place and sealed between the vial 12 and the cap 14. The ring is a separate element of the vial and the cap. The ring is an element of the container and is fitted to the vial and the cap. The ring 16 prevents accidental removal of the cap 14 and ensures the integrity of the container. The ring 16 surrounds the cap 14 to hold it in place in the neck of the vial 12. The ring 16 surrounds the vial 12 (to hold the cap 14 in the vial 12). The ring 16 may be screwed to the vial 12; preferably, the ring 16 is clipped (or resiliently engaged) to the vial 12. The ring 16 may comprise an opening 26 so as to surround the cap 14, leaving a portion of the top face 24 of the cap 14 uncovered for the access to the interior of the container by a needle through the cap. The ring 16 thus allows the cap 14 to be secured in place while allowing the substance to be injected into the container or withdrawn using a needle piercing the cap 14. The material of the ring 16 may withstand the above temperatures. The material is chosen to be impact-resistant, relatively rigid, lightweight and moldable. The ring material is, for example, a thermoplastic polymer such as acrylonitrile butadiene styrene (ABS). Advantageously, the ring 16 is non-removable, in the sense that its removal causes it to deteriorate. The ring 16 is not reusable. This helps to ensure the integrity of the container.

The container 10 comprising the medicinal substance in the vial 12 may be stored for an indefinite period at temperatures of −80° C. or below. When the container 10 is placed in storage, certain information useful for the subsequent use of the medicinal substance is not yet known. For example, the expiry date of the substance inside the container 10 may not be known because it depends on the date on which the container is removed from low-temperature storage. Thus, when the substance contained in the container 10 is to be used, the problem arises of providing the container with information useful for the subsequent use of the medicinal substance. Even more generally, the problem arises of indicating information on a container containing a medicinal substance, the container being removed from a low-temperature storage enclosure, in particular at temperatures of −80° C. or less. The solutions of labelling with glue, marking with ink (e.g. ink printing) or marking within the storage enclosure are not suitable for the reasons given elsewhere.

The disclosure proposes a simple marking solution. Thus, when the substance contained in the container 10 is to be used, the container is extracted from the storage enclosure and the container 10 may be marked even though frost is at least partially covering the container 10. The method according to the disclosure allows the container to be marked even if frost appears on the container when it leaves the storage enclosure. The method does not seek to avoid the appearance of frost, but allows marking even when frost appears. The method makes marking simple. The method simplifies the process of removing containers from the storage enclosure. In particular, the method comprises a step of laser marking the ring 16 through the frost. Firstly, this allows to avoid the need for a label to be glued onto the vial beforehand, and therefore avoids the use of glue which has to withstand the low temperatures mentioned and which risks migrating towards the substance and contaminating it. The laser avoids damaging the substance. The laser marking is quick and easy; the container remains cold and there is no waiting period for drying as with ink marking, for example. Moreover, the marking is very localized. Laser marking avoids contact with the container, which is weakened by low temperatures. In addition, the advantage of marking on the ring is that there is no contact with the vial itself, which contains the medicinal substance. The ring 16 is a separate element of the vial. The ring 16 is an element fitted to the vial. As the marking takes place on the ring 16, the marking is at a distance from the vial itself. The marking is not on the vial itself. There is no contact between the marking and the vial. This avoids the risk of heat transfer and/or degradation of the vial and prevents damage to the substance. As the ring 16 is around the vial when it is opened (the ring surrounds the vial when it is opened), the marking is at a distance from the vial itself, which avoids the heat transfer and the contamination of the vial and of the substance. The absence of contact with the vial (by marking on the ring and using the laser) is also preferable to avoid any potential contamination of the medicinal substance present in the container during marking; in this way, the integrity of the medicinal substance is preserved. In addition, marking through frost simplifies marking because it avoids the need for a prior frost removal step and/or for marking to be carried out in the storage enclosure (or at least under storage conditions) to avoid the appearance of frost. In this sense, the disclosure goes against all preconceptions of marking despite the presence of frost, and in particular the use of lasers through frost.

The laser is a nanosecond laser. A nanosecond laser is a pulsed laser, emitting very short pulses of light. Each pulse may have a very short duration, for example of the order of 1 to 350 nanoseconds (1 ns=10−9 s) and preferably between 4 ns and 100 ns. The advantage of these pulse durations is that there is little thermal effect due to the use of the laser, so the container is not damaged and the marking is more precise. This reduces the risk of affecting the substance. In addition, using such a long pulse duration for marking through frost allows limited energy to be applied with a high contrast effect while allowing the laser beam to diffuse through the frost. A laser of this type allows to ensure a precise marking. Moreover, marking the ring with such a laser further reduces the risk of heat spreading towards the vial and the substance.

The power of the laser is also chosen to limit the energy applied to the container and to apply a high-quality beam. The power may be, for example, a maximum of 20 W, or even less than 10 W, or even less than 4 W, or even less than 3 W, or even less than 2 W. A power of less than 4 W allows to make the right marking in less than a second. Using a laser with a maximum power of 20 W allows to limit the area of the ring affected thermally-making marking more precise and reducing the risk of affecting the container and the substance. Above 30 W power, thermal effects occur, making marking less precise and the risk of damaging the container greater.

To further improve the marking accuracy, it is advantageous to use a fiber laser (with short pulses, as mentioned). This allows to improve the resolution of the laser. It also allows a large amount of information to be marked on a small area. By way of example, a marking may be made in the form of a 12×12 code (i.e. a capacity of 10 numeric characters or 6 alphanumeric characters) or a 14×14 code (i.e. a capacity of 16 numeric characters or 10 alphanumeric characters), which may easily be marked in less than 1 s on a surface of 2 mm×2 mm offering an easy decoding-using a camera for example (dedicated reader or mobile phone). Marking may also be done in the form of a 10×24 rectangular code (i.e. a capacity of 32 numeric characters or 22 alphanumeric characters) that may easily be marked in less than 1.5 seconds on a 2 mm×4 mm surface that is easy to decode-using a camera for example (dedicated reader or mobile phone). This means that the marking may be made on the ring rather than on a label covering a large portion of the wall of the container. In addition, the use of a fiber laser allows a rapid marking within the timescales indicated above.

The laser wavelength may be visible or infrared, for example between 510 nm and 1200 nm. A good configuration combining cost and efficiency is between 1000 nm and 1100 nm, more specifically at 1064 nm. The repetition rate may be, for example, between 2 and 4000 KHz and preferably between 50 and 200 KHz. This also helps to limit the thermal effect, with all the advantages mentioned above.

The maximum intensity may be, for example, 1 mJ per pulse and preferably between 10 and 100 μJ. This allows to limit the thermal effect, with the advantages mentioned above, and reduces the cost.

The focal length of the laser is chosen so that marking may be carried out around the circumference without rotating the container. During marking, the container is immobile and the laser is mobile. This makes marking easier and avoids handling the container. A focal length of 160 mm allows a quality marking of the irradiated circumference and covers the positioning uncertainties and the manufacturing tolerances of the vial.

The resolution obtained within the scope of the method and device described is less than 75 μm. The resolution may also be less than 20 μm, allowing to increase the amount of information contained in the code and/or to introduce several levels of information such as anti-counterfeiting data.

It is also possible to combine the marking with a logo or text. This allows to increase the information available. It is also possible to repeat the marking on at least a portion of the circumference of the ring 16—or even on the entire circumference of the ring 16. This allows a random reading, particularly on a production line. In this way, it is not necessary to orientate the container in a certain way to access the information.

Data may be marked on the ring 16 in at least two passes. During the first pass, the laser makes an initial marking at the same time as it removes the layer of frost-the specificities of the laser indicated above allow these two actions to be carried out during the first pass. The energy applied by the laser is moderated to initiate the marking and remove the frost, while allowing the beam to diffuse through the frost. An extra pass (two passes in total) or several extra passes allow to accentuate the marking. For example, two additional passes (three in total) or even three additional passes (four in total) may be used to limit the energy required to mark the container accurately without any thermal effect, and to remove the frost from the first marking pass.

The scanning speed (or linear speed at which the passes are made) at which the passes are made may be, for example, between 700 and 3500 mm/s for marking and between 2000 and 10000 mm/s for jumps. This means that the passes may be made quickly to avoid heating up the container.

The marking speed for the entire marking process may be, for example, between 4 and 100 mm²/s, preferably between 20 and 80 mm²/s. This allows marking to be carried out quickly to avoid heating up the container.

According to FIG. 2, the ring 16 surrounds the cap 14 and comprises a collar 27. The laser marking step may be carried out on the collar. This allows to mark an available space on the ring 16 rather than on the vial, thereby reducing the risk of the vial becoming brittle. In addition, the marking on the collar, which is a side face of the ring 16, makes it easy to read the marking. The marking on the collar around the vial (when it is opened) prevents heat transfer and contamination of the vial and of the substance. According to FIG. 2, the vial 12 comprises an edge 29 around the neck 18, projecting outwards from the wall of the vial 12. The ring 16 is clipped (or resiliently engaged) to the underside of the edge 29. This allows the ring 16 to be held firmly to the vial 12—which is advantageous for the integrity of the marking-and therefore to hold the cap 14 in place—which is advantageous when using a needle through the cap 14 to access the inside of the container. The ring may also comprise a shoulder 28 bearing against the cap 14, the combination of the shoulder 28 on the cap and the ring 16 in engagement with the underside of the edge 29 reinforcing the quality of the seal of the container 10 and the retention in place of the ring 16-and therefore the integrity of the marking.

The container 10 may also comprise a removable or partially removable cap 32 (by removing the segment 34) covering the top face 24 of the cap 14, left uncovered by the ring 16. The cap 32 allows to protect the exposed top face 24 of the cap 14.

The cap 32 is outside the marking area of the ring 16. More specifically, the cap 32 does not cover the collar 27. The collar, which is a side face of the ring, is left uncovered by the cap 32. In this way, the presence of the cap 32 in place on the ring 16 does not prevent the marking on the ring 16 from being read.

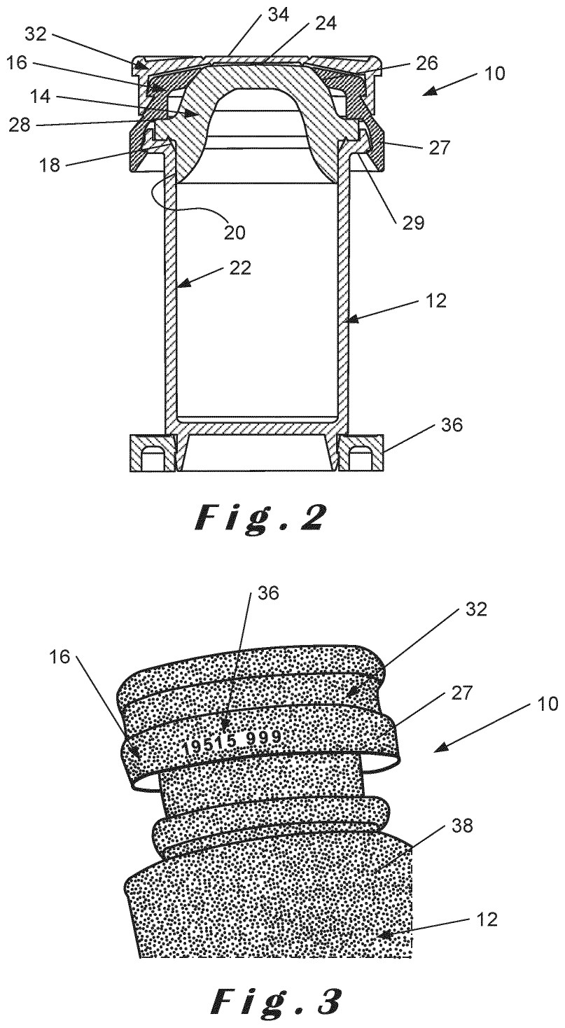

FIG. 3 shows an example of marking 36. The container 10 is at least partially covered with frost 38. The container 10 comprises the vial 12 (the shape of which is different from that shown in FIGS. 1 and 2, as the method may be applied to any shape of vial) and the cap 32 sits on top of the ring 16. The marking 36 is made on the ring 16 and, more specifically, on the collar 27. The cap 32 is outside the marking area on the ring 16. More specifically, the cap 32 does not cover the collar 27 of the ring 16, allowing laser marking 36 on the collar 27 with or without the presence of the cap 32. The presence of the marking 36 on a space available on one side face of the ring 16 makes it easy to read.

The laser may create a marking at different depths, visible or invisible to the naked eye. Several markings may be performed. This makes the marking or markings accessible to the naked eye or to a reading system, on the surface or in depth, making it almost impossible to remove them. The marking may be visible from a single viewing angle, change color depending on the viewing angle, or be visible only with appropriate lighting. For even greater safety, the angle at which the markings may be read may be distinctly changed. The marking may be visible to the naked eye, allowing the user to access the data quickly.

The marking may contain different data (or information) for example, the marking may be selected from the group of data comprising:
data configured to the end user, such as an expiry date;
data configured to identify the container and/or to manage the production, which may be an individual code, a standard code or a batch number linked to a database allowing to control the various parameters used to produce the marked container;
data configured to counterfeit expertise, such as an anti-fraud code.

The marking may be a combination of these data.

The marking may comprise identification data for the container, with some of the bits in the identification data defining the position of an invisible anti-fraud code produced by the same method.

The marking may be invisible in daylight but visible at an appropriate wavelength using a reading system with a camera sensitive to that wavelength, providing an anti-fraud signature.

The marking may be data comprising a series of numeric, alphabetic or alphanumeric characters, a 2D matrix, a data-matrix code, a barcode, a logo, a decorative element, etc. and/or a combination of these data. The marking may be included or concealed in a decorative or informative element of the ring. For example, the marking may be in a logo or a text. For example, the marking could be a data-matrix code in the dot of an “i”, or even in one of the squares of a data-matrix code.

The disclosure also relates to a device for marking the container 10. The device has the particularity of marking the container 10 covered at least in part with frost. The device also has the particularity of marking the container 10 without any thermal effect, without any risk of contamination of the substance contained in the vial. The device comprises a laser, as described above, to mark the container 10. In particular, the device allows the described method to be implemented. The device may also comprise members for holding a container to be marked in a stationary position, and means for moving the laser to mark the container.

The present disclosure has been described above in connection with specific embodiments, which are illustrative and should not be considered limiting. In general, it will be apparent to a person skilled in the art that the present disclosure is not limited to the examples illustrated and/or described above. For example, the cap and the ring could be in one-part, and/or the shape of the cap and the ring could be different, as long as the marking is without risk of contamination of the substance, does not harm the integrity of the container and is readable.

1. A method for marking a container comprising a vial containing a medicinal substance and closed by a cap secured to the vial by a ring, the container being at least partially covered with frost, and the method comprises a step of laser marking the ring through the frost.

2. The method according to claim 1, wherein the medicinal substance consists of cells.

3. The method according to claim 1, wherein at least one operating parameter of the laser is selected from a group comprising:
a wavelength between 510 nm and 1200 nm, preferably between 1000 nm and 1100 nm, more preferably at 1064 nm;
a power of less than 20 W, preferably less than 10 W, more preferably less than 4 W, more preferably less than 3 W, more preferably less than 2 W;
a marking speed of between 4 and 100 mm² per second, preferably between 20 and 80 mm² per second;
a laser pulse duration of between 1 and 350 ns nanoseconds, preferably between 4 and 100 ns;
a repetition rate between 2 and 4000 kHz and preferably between 50 and 200 kHz; and
an intensity of 1 mJ per pulse, preferably between 10 and 100 μJ.

4. The method according to claim 1, wherein the laser is a fiber laser.

5. The method according to claim 1, wherein the marking of the ring is carried out in at least two passes of the laser on the ring, preferably three passes, more preferably four passes.

6. The method according to claim 1, wherein the ring surrounds the cap and comprises a collar on which the laser marking step is carried out.

7. The method according to claim 1, wherein the ring surrounds the cap leaving an uncovered portion of a top face of the cap for an access to an inside of the container by a needle through the cap, the container further comprising a partially or totally removable cap which covers the uncovered portion of the top face of the cap and which is outside the marking area of the ring.

8. The method according to claim 1, wherein the cap is made of a thermoplastic material.

9. The method according to claim 1, wherein the vial is made of polymer, preferably cyclic olefin copolymer or cyclic olefin polymer.

10. The method according to claim 1, wherein, prior to the marking step, the container has been stored at −80° C. or below.

11. The method according to claim 1, wherein the marking is selected from the group of data comprising an expiry date, an individual code, a batch number, an anti-fraud code, a normative code, or a combination of these data.

12. The method according to claim 1, wherein the marking is included in a decorative element of the container.

13. The method according to claim 1, wherein the marking comprises identification data for identifying the container, a portion of the bits of the identification data define the position of an invisible anti-fraud code produced by the same method.

14. The method according to claim 1, wherein, during marking, the container is immobile and the laser is mobile.

15. The method according to claim 1, wherein the marking comprises a 12×12 or 14×14 code on an area of 2 mm×2 mm or a 10×24 code on an area of 2 mm×4 mm.

16. The method according to claim 1, wherein the marking is repeated over at least a portion of the circumference of the ring.

17. A device for marking a container comprising a vial containing a medicinal substance and closed by a cap secured to the vial by a ring, the container being at least partially covered with frost, and the device comprising a laser capable of marking the ring through the frost.

18. The device according to claim 17, wherein at least one operating parameter of the laser is selected from the group comprising
a wavelength between 510 nm and 1200 nm, preferably between 1000 nm and 1100 nm, more preferably at 1064 nm;
a power of less than 20 W, preferably less than 10 W, more preferably less than 4 W, more preferably less than 3 W, more preferably less than 2 W;
a marking speed of between 4 and 100 mm² per second, preferably between 20 and 80 mm² per second;
a laser pulse duration of between 1 and 350 ns nanoseconds, preferably between 4 and 100 ns;
a repetition rate between 2 and 4000 kHz and preferably between 50 and 200 kHz; and
an intensity of 1 mJ per pulse, preferably between 10 and 100 μJ.

19. The device according to claim 17, wherein the laser is a fiber laser.

20. The device according to claim 17, wherein, during marking, the container is immobile and the laser is mobile.
